(19) United States
(12) Patent Application Publication
(10) Pub. No.: US 2021/0333780 A1
(43) Pub. Date: Oct. 28, 2021

(54) USER INPUT MODULE FOR AN AUTOMATION ENGINEERING FIELD DEVICE, AND SAME FIELD DEVICE

(71) Applicant: Endress+Hauser SE+Co. KG, Maulburg (DE)

(72) Inventors: Junaid Ali Shah, Steinen (DE); Mathieu Weibel, Neuwiller (FR); Mike Frank, Lörrach (DE)

(21) Appl. No.: 17/286,612

(22) PCT Filed: Sep. 16, 2019
(86) PCT No.: PCT/EP2019/074705

§ 371 Date: Apr. 19, 2021

(30) Foreign Application Priority Data
Oct. 22, 2018 (DE) 10 2018 126 231.0

(51) Int. Cl. G05B 19/4155

(52) U.S. Cl. CPC G05B 19/4155; G06F 3/04886; G05B 2219/31368

(57) ABSTRACT

A user input module for an automation engineering field device comprising: at least one user input element without haptic feedback; an electronic unit configured to detect instances of operation of the user input elements, to prompt a first feedback for a user when an instance of operation of one of the user input elements is detected, which instance of operation lasts in particular for longer than a first prescribed period, and to prompt a second feedback for the user when an instance of operation of one of the user input elements is detected, which instance of operation lasts for longer than a second prescribed period, wherein the second period is longer than the first period, and an automation engineering field device that has the user input module according to the invention.

The invention relates to an operating module for an automation engineering field device. The invention also relates to an automation engineering field device which comprises the operating module according to the invention.

Field devices that are used in industrial plants are already known from the prior art. Field devices are often used in process automation as well as in manufacturing automation. Field devices, in principle, refer to all devices which are used in process-oriented manner and which supply or process process-relevant information. Field devices are thus used for detecting and/or influencing process variables. Measuring devices, or sensors, are used for detecting process variables. These are used, for example, for pressure and temperature measurement, conductivity measurement, flow measurement, pH measurement, fill-level measurement, etc., and detect the corresponding process variables of pressure, temperature, conductivity, pH value, fill-level, flow, etc. Actuators are used for influencing process variables. These are, for example, pumps or valves that can influence the flow of a fluid in a pipe or the fill-level in a tank. In addition to the aforementioned measuring devices and actuators, field devices are also understood to include remote I/O's, radio adapters, or, generally, devices that are arranged at the field level.

A variety of such field devices is produced and marketed by the Endress+Hauser group.

In modern industrial systems, field devices are usually connected to higher-level units via communication networks, such as fieldbuses (Profibus®, Foundation® Fieldbus, HART®, etc.). Higher-level units are control units, such as an SPS (storage programmable controller) or a PLC (programmable logic controller). The higher-level units are used for, among other things, process control, as well as for commissioning of the field devices. The measured values detected by the field devices, especially by sensors, are transmitted via the respective bus system to a (or possibly several) higher-level unit(s) that further process the measured values, as appropriate, and forward them to the control station of the plant. The control station serves for process visualization, process monitoring and process control via the higher-level units. In addition, a data transfer is also required from the higher-level unit via the bus system to the field devices, especially for configuration and parameterization of field devices, as well as for control of actuators.

For operating the field devices, corresponding operating programs (operating tools) are necessary which either run independently on the higher-level units (Endress+Hauser FieldCare, Pactware, AMS Fisher-Rosemount, PDM Siemens) or are integrated in applications of the control station (Siemens PCS7, ABB Symphony, Emerson Delta V). The term “operate” means, inter alia, parameterizing the field device, updating the field device and/or requesting and visualizing process data and/or diagnostic data of the field device.

It is furthermore known to connect an operating unit to the field device, in order to operate the field device by means of this operating unit. Examples of such operating units are operating units in the sense of the Field Xpert, which is produced and sold by the applicant, as well as mobile end devices, such as smartphones or tablets, which for this purpose can execute special applications, such as the SmartBlue application provided by the applicant. The connection to the field device is generally wired (Field Xpert) or wireless, e.g., via Bluetooth (mobile end devices).

Most of the field devices on the market have operating modules which have a display unit with one or more mechanical pushbutton elements by means of which the field device can be operated. For example, a menu visualized on the display element can be navigated and settings of the field device can be changed or entered via the menu, and statuses and measured values of the field device can be retrieved. When actuated, these pushbutton elements generally output haptic feedback, e.g., in the form of a click, via which the operator receives a confirmation of the actuation of the pushbutton element.

The operating modules of modern field device types have optoelectronic operating elements. These serve as a replacement for mechanically actuated pushbutton elements and enable the construction of hermetically encapsulated field devices. The functionality of such optoelectronic operating elements is explained, for example, in DE 20 2016 117 289 A1.

The disadvantage of these optoelectronic operating elements, as well as alternative operating elements without haptic feedback, is that an operator does not receive an immediate confirmation as to whether the operating element was actuated via an operating action or not. Particularly complex operating processes, which require actuating a plurality of such operating elements or require longer holding of one operating element, may have to be carried out multiple times, in order to execute the operating action correctly.

Proceeding from this problem, the invention is based on the object of increasing the operating comfort for an automation engineering field device which has operating elements without haptic feedback.

The object is achieved by an operating module according to claim 1 and by an automation engineering field device according to claim 6.

The operating module according to the invention is provided for an automation engineering field device and comprises:
one or more operating elements, especially without haptic feedback;
an electronic unit designed
   i. to detect actuations of the operating elements,
   ii. to cause a first feedback for an operator in the event that an actuation of one of the operating elements is detected, which actuation especially lasts longer than a first prescribed time period, and
   iii. to cause a second feedback for the operator in the event that an actuation of one of the operating elements is detected, which actuation lasts longer than a second prescribed time period, wherein the second time period is longer than the first time period.

The operating module according to the invention offers an operator the advantage that he receives immediate feedbacks for two different operating actions: The conventional, brief pressing of the operating element and the holding of the operating element.

With regard to the pressing of the operating element, there is a wait of a short time period, e.g., 50 milliseconds, as to whether this is actually an intended operating action. Subsequently, the first feedback is output.

In the event that the actuation of the operating element lasts longer than the defined second time period, e.g., 500 milliseconds, this corresponds to the holding of the operating element, whereupon the second feedback is triggered. Complex operating actions can thus be executed with increased comfort or with an increased success rate.

The method according to the invention can alternatively also be advantageously used for operating elements which have haptic feedbacks, e.g., mechanical pushbuttons. In this way, the operator can determine, for example, that the operating element is defective or that the device to be operated no longer responds.

According to a first variant of the operating element according to the invention, it is provided that the operating element is an optoelectronic operating element. Such an optoelectronic operating element usually has a transparent operating panel which is arranged on the outside of the housing of the operating module and which represents a contact surface for actuation by the operator. Usually, such an optoelectronic operating element is based on the principle of the “open light barrier” in which infrared light is emitted by a transmitting/receiving pair; this light is reflected or scattered at a finger or other scattering object and is received via a receiver, e.g., a photodiode. In the event that a threshold exceeding or a switching reference level is exceeded, a touch of the operating element by the finger or the other scattering object is detected, which in the figurative sense equates to pressing a button in the case of a mechanical pushbutton or switch.

According to a second variant of the operating element according to the invention, it is provided that the operating element is an element visualized on a touch-sensitive display element. The touch-sensitive display element is especially a touchscreen.

According to a third variant of the operating element according to the invention, it is provided that the operating element is a radar-based operating element. The operating element is designed to emit radar waves. The operator places his finger or his hand at a predetermined distance in front of the operating element, as a result of which the radar waves are reflected on the finger or on the hand back to the operating element. By evaluating the received signal, for example by means of the transit time method, this is recognized as an actuation of the operating element. An example of such an operating element is the product “Soli”, which was developed by Google and Infineon.

In an advantageous embodiment of the operating element according to the invention, it is provided that, in the event that actuations of more than one of the operating elements are detected, distinguishable feedbacks that can be attributed to the respective actuated operating element are caused. As a result, the operator receives feedback as to which of the operating elements is currently being operated. The operator also in each case receives feedback as to which of the operating actions “pressing” or “holding” is currently being performed by him at which operating element.

The automation engineering field device according to the invention is designed to detect at least one physical variable of a measured medium or to influence at least one variable of a process engineering process and has the operating module according to the invention. Examples of such field devices are already described in the introductory part of the description.

According to a first variant of the field device according to the invention, it is provided that the field device or the operating module has a display unit, especially an LCD display, which is designed to visualize a first symbol as a first feedback and to visualize a second symbol as a second feedback. For example, it is provided that the outline of a symbol, for example of a circle, a rectangle or any other shape, is visualized as a first feedback and that the filled symbol is visualized as a second feedback. The operating element is arranged especially next to or above or below the display, such that the symbol is visualized on the display at the height of the operating element. In the event that a plurality of operating elements are provided, they are correspondingly arranged next to one another, one above the other or one below the other. The visualized symbols are then correspondingly arranged next to one another, one above the other or one below the other, such that an operation can unambiguously be assigned to one of the operating elements. It can also be provided that different symbol shapes are provided for each of the operating elements, in order to be able to unambiguously assign an operation to an operating element.

According to a second variant of the field device according to the invention, it is provided that the field device or the operating module has a light-emitting component, especially an LED, which is designed to output a first light signal having a first color, a first flashing frequency and/or a first amplitude as a first feedback and to output a second light signal having a second color, a second flashing frequency and/or a second amplitude as a second feedback. In the event that a plurality of operating elements are present, it can be provided that one light-emitting component per operating element is provided.

According to a third variant of the field device according to the invention, it is provided that the field device or the operating module has an acoustic reproduction means, especially a speaker, which is designed to output a first audio signal as a first feedback and to output a second audio signal which is different from the first audio signal as a second feedback.

According to a fourth variant of the field device according to the invention, it is provided that the field device or the operating module has a vibration element, especially a vibration motor, which is designed to output a first vibration signal having a first time period and/or a first vibration strength as a first feedback and to output a second light signal having a second time period and/or a second vibration strength as a second feedback. Such a vibration element is preferably arranged directly next to or below an operating element, in order to amplify the vibration effect. In the event that a plurality of operating elements are present, it can be provided that one vibration element per operating element is provided. In this case, the vibration elements are advantageously decoupled from one another, such that the vibrations can in each case only be perceived at the operating element currently being actuated, in order to especially be able to unambiguously assign actuations of a plurality of operating elements.

According to an advantageous embodiment of the field device according to the invention, it is provided that, after the first feedback has been caused exclusively and the actuation of the operating element has subsequently ended, the electronic unit is designed to execute a first operating action on the field device.

According to an advantageous embodiment of the field device according to the invention, it is provided that the first operating action is one of the following:
causing a menu structure of the field device (FG) to be visualized on the display unit of the field device (FG);
selecting an action in the menu structure;
confirming a selection in the menu structure.

It can also be provided that a plurality of operating elements are actuated simultaneously. These respectively output a separate feedback. In the event that both actuations are ended after the first feedback has been output, a special operating action can be executed; for example, a change in the level of the menu structure is caused in this way.

According to an advantageous embodiment of the field device according to the invention, it is provided that, after the second feedback has been caused and the actuation of the operating element has subsequently ended, the electronic unit is designed to execute a second operating action.

According to an advantageous embodiment of the field device according to the invention, it is provided that the second operating action is one of the following:
scrolling through a menu structure selected on the display unit (AE) of the field device (FG);
displaying a help text on the display unit (AE) of the field device (FG).

In the event that a plurality of operating elements are actuated and that both actuations are ended after outputting the second feedback, a further special operating action can be executed; for example, closing of the menu structure can be caused in this way.

The invention is described in more detail with reference to the following figures. The following are shown:

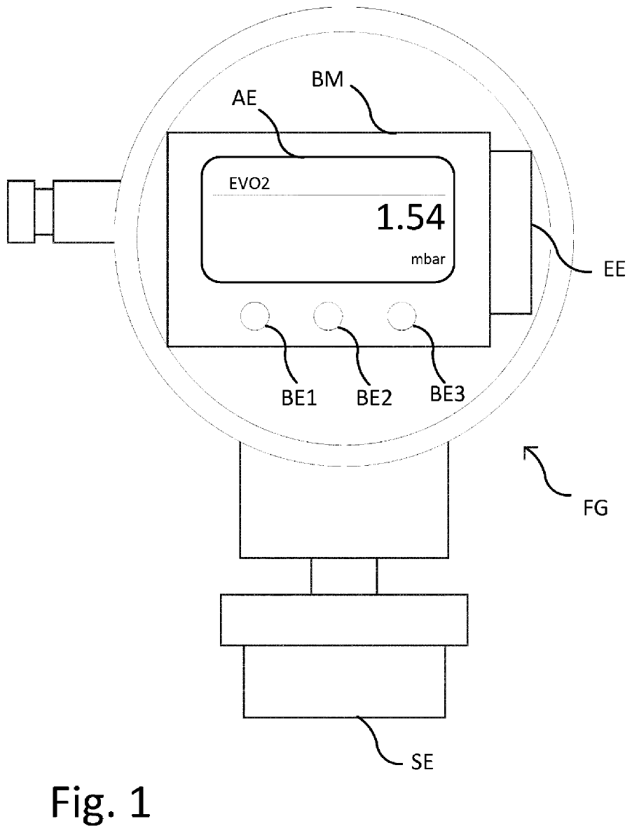

FIG. 1: a first exemplary embodiment of a field device according to the invention which has an operating module according to the invention;

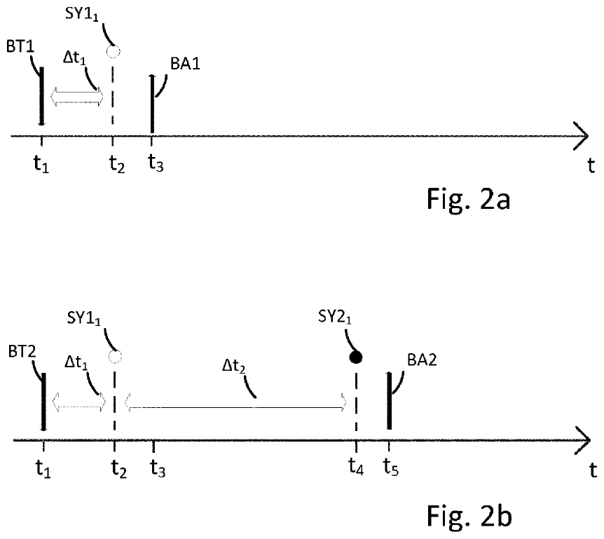

FIG. 2: time profiles for examples of operating possibilities by means of the operating module;

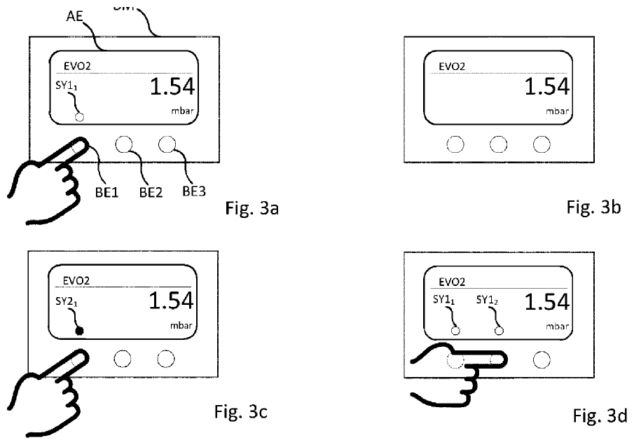

FIG. 3: exemplary embodiments for outputting feedback for various operating actions;

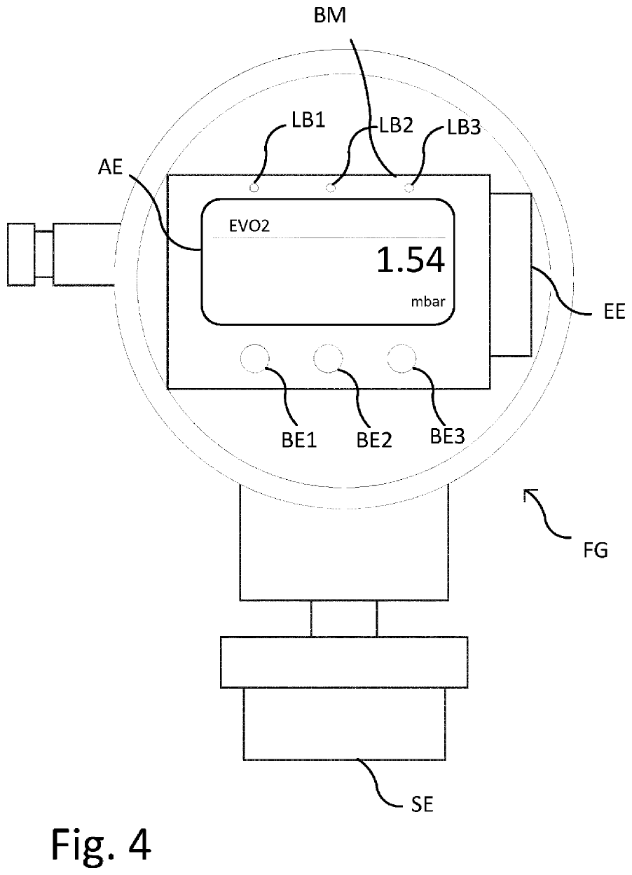

FIG. 4: a second exemplary embodiment of the field device according to the invention; and

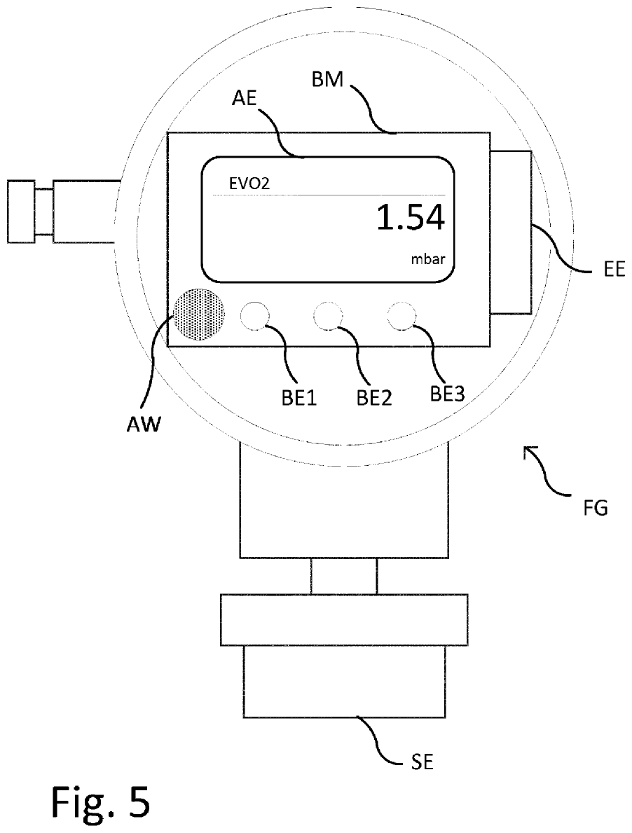

FIG. 5: a third exemplary embodiment of the field device according to the invention; and

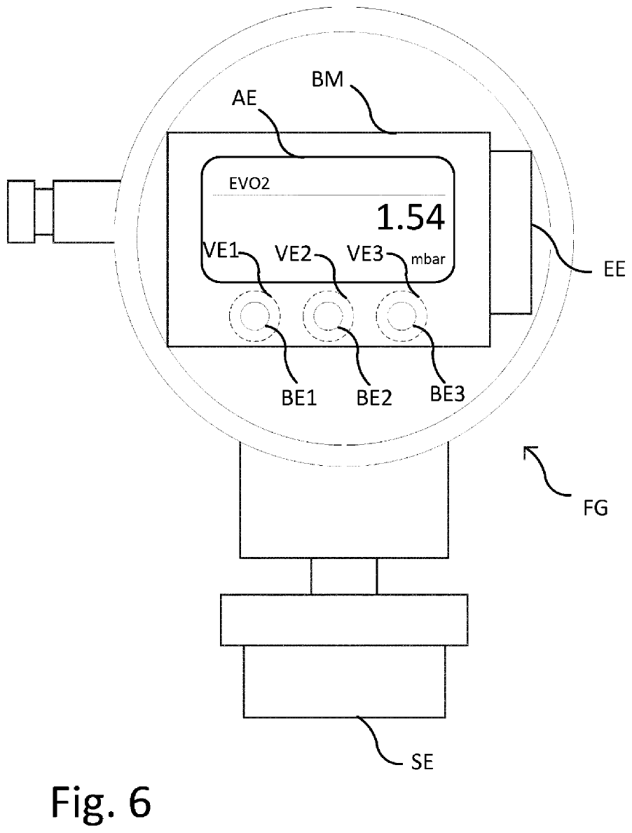

FIG. 6: a fourth exemplary embodiment of the field device according to the invention.

FIG. 1 shows a first exemplary embodiment of an automation engineering field device FG. This field device FG is a pressure measuring device and has a corresponding sensor unit SE for measuring the pressure. For operating the field device FG, the latter has an operating module BM. The latter consists of a display unit AE and three operating elements BE1, BE2, BE3 without haptic feedback, which operating elements work according to the optoelectronic method. The operating module BM furthermore has an electronic unit EE. The latter controls the functioning of the components AE, BE1, BE2, BE3 of the operating module BM and is designed to forward, to the electronics of the field device FG, operating commands output by the operating module.

FIG. 2 shows the schematic sequence of several operating actions which can be carried out at the operating module.

In FIG. 2a, the “pressing” operating mode of one of the operating elements BE1, BE2, BE3 is outlined. At a first point in time t1, the operator BD carries out an actuation BT1 of the operating element BE1 of the operating module BM. In case optoelectronic operating elements BE1, BE2, BE3 are used as shown in this exemplary embodiment, the operating element BE1 is covered by the operator, for example by means of a finger or an object, e.g., a stylus.

So that short, inadvertent actuations are not evaluated as an operating action, it can be provided that the operating element BE1 has to be actuated for more than a predetermined first time period Δt₁ in order to trigger a first operating action BA1. The time period Δt₁ is, for example, 50 milliseconds. After the predetermined first time period Δt₁ has elapsed, the display element visualizes a first symbol SY1₁ in the form of a circular outline, which symbol is arranged essentially above the position of the operating element BE1. FIG. 3a schematically shows the actuation BT1 of the first operating element BE1 by the operator BD and the arrangement of the thereupon visualized first symbol SY1₁ on the display unit AE of the operating module BM.

The operator BD1 subsequently lifts the finger or the object off the operating element BE1 and thereby ends the actuation BT1. The visualization of the first symbol SY1₁ on the display unit AE is likewise ended. This is shown in FIG. 3b. A signal is also caused to be emitted to the electronics of the field device FG, which electronics executes a first operating action BA1. Alternatively, the electronic unit EE of the operating module BM itself carries out the first operating action BA1.

In FIG. 2b, the “pressing” operating mode of one of the operating elements BE1, BE2, BE3 is outlined. At a first point in time t₁, the operator BD carries out an actuation BT2 of the operating element BE1 of the operating module BM. Analogously to the “pressing” operating action, the first symbol SY1₁ is visualized on the display unit AE of the operating module BM after the expiration of the first time period Δt₁. Instead of ending the actuation BT2, there is then a wait of a second time period t₂, which is, for example, 500 milliseconds. After the expiration of the second time period Δt₂, at a point in time t₄, the first symbol SY1₁ changes to a second symbol SY2₁, here a filled circle. FIG. 3c schematically shows the actuation BT2 of the first operating element BE1 by the operator BD and the arrangement of the thereupon visualized first symbol SY2₁ on the display unit AE of the operating module BM.

The operator BD1 subsequently lifts the finger or the object off the operating element BE1 and thereby ends the actuation BT2. The visualization of the second symbol SY1₁ on the display unit AE is likewise ended. A signal is also caused to be emitted to the electronics of the field device FG, which electronics executes a second operating action BA2. Alternatively, the electronic unit EE of the operating module BM itself carries out the second operating action BA2.

These two operating modes are also simultaneously provided for a plurality of operating elements BE1, BE2, BE3. FIG. 3d shows, for example, a simultaneous “pressing” of the operating elements BE1 and BE2. In this case, a separate symbol SY1₁, SY1₂ is visualized on the display unit AE for each operating element BE1, BE2. In this case, the symbols SY1₁, SY1₂ are designed identically. However, it can also be provided that different symbol shapes are visualized for each of the operating elements BE1, BE2, BE3. The operating modes can be executed independently of one another in time, in order to execute special operating actions. For example, it may be provided to execute the “holding” operating mode with the operating element BE1. By “pressing” an operating elements BE2 and BE3 while the operating element BE1 is held, a special menu, which is visualized on the display unit AE, can, for example, be opened or a temporary blocking of the operating module BM can be brought about.

The shape of the symbols SY1₁, SY1₂, SY2₁ is freely selectable and is not limited to circular shapes. The number of operating elements BE1, BE2, BE3, the arrangement of the operating elements BE1, BE2, BE3 on the operating module BM, and the arrangement and the size of the symbols SY1₁, SY1₂, SY2₁ on the display unit AE are also freely selectable and are not limited to the exemplary embodiments shown in FIGS. 1 to 3.

Alternatively, it can also be provided to use further types of feedback:

FIG. 4 thus shows a second exemplary embodiment of the field device FG. The operating module BM additionally has three light-emitting components LB1, LB2, LB3 in the form of LEDs, wherein in each case one light-emitting component LB1, LB2, LB3 is assigned to one operating element BE1, BE2, BE3. The light-emitting components LB1, LB2, LB3 can be designed to illuminate in the course of the triggering of the “pressing” operating mode of the corresponding operating element BE1, BE2, BE3. For example, in the “pressing” operating mode, the light-emitting components LB1, LB2, LB3 flash at a first frequency or emit light of a specific color. In the “holding” operation mode, the light-emitting components LB1, LB2, LB3 flash at a second frequency or illuminate in a different color.

A third exemplary embodiment of the field device is depicted in FIG. 5. The operating module BM additionally has an acoustic reproduction means AW in the form of a membrane speaker, for example. The acoustic reproduction means can be designed to generate an acoustic signal in the course of the triggering of the “pressing” operating mode of an operating element BE1, BE2, BE3. For example, the acoustic reproduction means AW outputs the acoustic signal in the “pressing” operating mode at a first pitch or for a specific time period. In the “holding” operating mode, the acoustic reproduction means AW outputs the acoustic signal at a different pitch and/or for a longer time period.

A fourth, final exemplary embodiment of the field device is depicted in FIG. 6. The operating module BM additionally has three vibration elements VE1, VE2, VE3 in the form of vibration motors, wherein one vibration element VE1, VE2, VE3 each is assigned to an operating element BE1, BE2, BE3 and is especially mounted directly below it. The vibration elements VE1, VE2, VE3 are advantageously decoupled from one another, such that the vibrations can in each case only be perceived at the operating element BE1, BE2, BE3 currently being actuated, in order to especially be able to unambiguously assign actuations of a plurality of operating elements BE1, BE2, BE3.

The vibration elements VE1, VE2, VE3 can be designed to vibrate in the course of the triggering of the “pressing” operating mode of the corresponding operating element BE1, BE2, BE3 in such a way that the operator BD immediately perceives the vibration, especially via the finger or object used for actuation. For example, in the “pressing” operating mode, the vibration elements VE1, VE2, VE3 vibrate at a first vibration strength or for a specific time period. In the “holding” operating mode, the vibration elements VE1, VE2, VE3 vibrate at a different vibration strength or for a longer time period.

The time sequences which are shown in FIGS. 2a and 2b and which are outlined in connection with the first exemplary embodiment can be transferred analogously to the further exemplary embodiments.

As an alternative to optoelectronic operating elements, any operating elements BE1, BE2, BE3 which do not have haptic feedback may be used within the scope of each of the exemplary embodiments. Radar-based operating elements may be used, for example. Alternatively, a touchscreen that visualizes the operating elements is used.

### LIST OF REFERENCE SIGNS

AE Display unit
AW Acoustic reproduction means
BA1, BA2 Operating actions
BD Operator
BE1, BE2, BE3 Operating elements
BT1, BT2 Actuations
BM Operating module
EE Electronic unit
FG Field device
LB1, LB2, LB3 Light-emitting components
SE Sensor element
SY1₁, SY1₂, SY2₁ Symbols
t₁, t₂, t₃, t₄, t₅ Points in time
Δt₁, Δt₂ Time period
VE1, VE2, VE3 Vibration elements

1-14. (canceled)

15. An operating module for an automation engineering field device, comprising:
one or more operating elements without haptic feedback; and
an electronic unit designed:
to detect actuations of the operating elements,
to cause a first feedback for an operator when a first actuation of one of the operating elements is detected, wherein the first actuation is longer than a first time period, and
to cause a second feedback for the operator when a second actuation of one of the operating elements is detected, wherein the second actuation lasts for longer than a second time period, wherein the second time period is longer than the first time period.

16. The operating module according to claim 15, wherein the operating elements are optoelectronic operating elements.

17. The operating module according to claim 15, wherein the operating elements are elements visualized on a touch-sensitive display unit.

18. The operating module according to claim 15, wherein the operating elements are radar-based operating elements.

19. The operating module according to claim 15, wherein, in the event that actuations of more than one of the operating elements are detected, distinguishable feedbacks that can be attributed to the respective actuated operating element are caused.

20. An automation engineering field device for detecting at least one physical variable of a measured medium or for influencing at least one variable of a process engineering process, comprising:
an operating module, including:
one or more operating elements without haptic feedback; and
an electronic unit designed:
to detect actuations of the operating elements,
to cause a first feedback for an operator when a first actuation of one of the operating elements is detected, wherein the first actuation is longer than a first time period, and
to cause a second feedback for the operator when a second actuation of one of the operating elements is detected, wherein the second actuation lasts for longer than a second time period, wherein the second time period is longer than the first time period.

21. The field device according to claim 20, wherein the field device or the operating module includes a display unit designed to visualize a first symbol as a first feedback and to visualize a second symbol as a second feedback.

22. The field device according to claim 20, wherein the field device or the operating module includes a light-emitting component designed to output a first light signal having a first color, a first flashing frequency, and/or a first amplitude as a first feedback and to output a second light signal having a second color, a second flashing frequency, and/or a second amplitude as a second feedback.

23. The field device according to claim 20, wherein the field device or the operating module includes an acoustic reproduction means designed to output a first audio signal as a first feedback and to output a second audio signal which is different from the first audio signal as a second feedback.

24. The field device according to claim 20, wherein the field device or the operating module includes a vibration element designed to output a first vibration signal having a first duration and/or a first vibration strength as a first feedback and to output a second vibration signal having a second duration and/or a second vibration strength as a second feedback.

25. The field device according to claim 20, wherein, after the first feedback has been caused exclusively and the actuation of the corresponding operating element has subsequently ended, the electronic unit is designed to execute a first operating action on the field device.

26. The field device according to claim 25, wherein the first operating action is one of the following:
causing a menu structure of the field device to be visualized on the display unit of the field device;
selecting an action in the menu structure; and
confirming a selection in the menu structure.

27. The field device according to claim 20, wherein, after the second feedback has been caused and the actuation of the corresponding operating element has subsequently ended, the electronic unit is designed to execute a second operating action.

28. The field device according to claim 27, wherein the second operating action is one of the following:
scrolling through a menu structure selected on the display unit of the field device; and
displaying a help text on the display unit of the field device.
